(19) United States
(12) Patent Application Publication
(10) Pub. No.: US 2005/0155416 A1
(43) Pub. Date: Jul. 21, 2005

(54) System and method for measuring shrinkage behaviour and modulus change during solidification of a polymeric resin

(75) Inventors: Paul Ouellette, MONREAL, QUEBEC (CA); Suong Van Hoa, Brossard (CA)

Correspondence Address: FULBRIGHT & JAWORSKI, LLP, 600 CONGRESS AVENUE, SUITE 2400, AUSTIN, TX, 78701, US

(73) Assignee: CONCORDIA UNIVERSITY, MONTREAL (CA)

(21) Appl. No.: 10/504,883

(22) PCT Filed: Feb. 14, 2003
(86) PCT No.: PCT/CA03/00217

(30) Foreign Application Priority Data
Feb. 15, 2002 (CA) 2,372,261

(51) Int. Cl. G01N 29/18; G01N 29/02

(52) U.S. Cl. 73/64.42; 73/597; 73/602; 73/627; 73/644; 702/54

(57) ABSTRACT

A method and a system for measuring the variation of volume and modulus during the solidification of a polymeric resin are provided, which use ultrasonic waves propagating through a sample and a coupling medium. On the one hand, the time of travel of the part of a signal that is reflected at the interface between the sample and the coupling medium back to the ultrasound transducer, gives the position of the interface between the sample and the coupling medium. This information may be used to determine the shrinkage of the sample. On the other hand, the time of travel of part of a signal that propagates through the thickness of the sample and then reflects from the bottom of the sample at the interface between the sample and a container in which it is contained may be used to determine the degree of stiffness of the sample. The time of travel is of the order of the microsecond and the change of thickness of the sample is of the order of a few hundred micrometers.

### FIELD OF THE INVENTION

The present invention relates to polymeric resins and composites. More specifically, the present invention is concerned with a method and system for measuring a variation of volume, especially a variation of shrinkage and modulus, during solidification of a polymeric resin.

### BACKGROUND OF THE INVENTION

Nowadays, polymer materials constitute a large proportion of the materials used in engineering applications. Due to their very nature, polymers, particularly thermoset polymers such as epoxies and polyesters, are transformed from a liquid state to a solid state during a curing process. This curing process results in a reduction in volume of a sample, referred to as shrinkage, as well as in a change in stiffness as measured in terms of a modulus.

Such parameters as shrinkage and modulus need to be. monitored in a variety of applications involving polymer resins such as thermoset polymers and polymer composites for example, since they are related to potential problems.

A first example relates to polymer composites used in making components for aircraft structures, automobile parts, pipes or reservoirs for instance, since the shrinkage and change of modulus give rise to dimensional variations and residual stress in the finished product. Models aiming at simulating the behavior of shrinkage and modulus are still inaccurate due the lack of an effective method for measuring experimental data related thereto. In the specific case when polymer composites are used for making automotive bodies, the lack of data concerning shrinkage and modulus change have been hindering, for more than 20 years now, the progress of models permitting the computation of adequate conditions in order to obtain a controlled surface finish.

A second example deals with polymer composites used for making teeth. The resin making up an artificial tooth to be fixed on a crown cools and shrinks onto the shaft of the tooth. A detailed understanding of the. shrinkage steps of the resin throughout its solidification history is needed, since in the case where the resin does not shrink properly, the adhesion to the shaft of the artificial tooth is jeopardized, which results in an insecurely mounted tooth. Even though numerous studies are dedicated to develop finite element models of the solidification behavior of the resin, the models are still not accurate enough, due, once again, to the lack of material data.

As is suggested from the foregoing, adhesives are used for bonding components together in a variety of industrial and everyday applications and the dimensional control of the final parts depends on the shrinkage behavior and change of modulus of the resins upon solidification.

Therefore, there is a need for an easy and simple method and system enabling measurement of such important properties as the shrinkage and the stiffness of polymeric resins as they are being polymerized, during solidification or curing.

### OBJECTS OF THE INVENTION

An object of the present invention is therefore to provide an improved system and method for measuring the shrinkage behavior and modulus change of a polymeric resin during solidification.

### SUMMARY OF THE INVENTION

More specifically, in accordance with the present invention, there is provided a system for measuring the shrinkage behavior and modulus change during solidification of a polymeric resin making use of ultrasound signals, comprising an ultrasonic transducer, a sample of the polymeric resin and a coupling medium in a container, the coupling medium being on top of the sample and in such an amount as to partially immerse the ultrasonic transducer held in a fixed vertical position relative an inside bottom surface of the container, wherein the coupling medium transmit an ultrasonic signal from the ultrasonic transducer to the sample, the ultrasonic transducer producing the ultrasonic signal characterized by a power and time envelope allowing at least two first reflections from an interface between the coupling medium and the sample and a first reflection from an interface between the sample and the inside bottom surface of the container.

The present invention further provides a method for measuring a variation of material parameters of a polymeric resin upon solidification thereof, comprising the steps of:
a) providing a sample of the polymeric resin in a container;
b) providing a test coupling medium on top of the sample of the polymeric resin in the container;
c) providing an ultrasonic transducer in a fixed position relative an inside bottom surface of the container and partially immersed in the test coupling medium;
d) allowing the ultrasonic transducer to send a signal to the sample through the test coupling medium;
e) collecting a first reflected signal and a second reflected signal from an interface between the test coupling medium and the sample, and a first reflected signal from the interface between the sample and the inside bottom surface of the container;
f) storing the reflected signals with a corresponding process time t and test coupling medium temperature T_{c} at the time t;
g) repeating steps d) to f) until solidification of the sample is complete; and
h) processing the reflected signals.

The method according to any of claims 15 to 20, wherein said step of processing the reflected signals comprises:
i) computing a thickness of the sample by measuring a time of flight TOF_{c} between the first and second echoes from the interface between the test coupling medium and the sample using the relation h=L−w where w is given by: w=v_{c}×TOF_{c}/2 (3) where v_{c} is a speed of sound in the test coupling medium at a temperature T_{c} of the test coupling medium;
ii) computing the volume V of the sample as a product of the thickness h by a cross sectional area Ai of the container, as follows: V=hπ[C/π]²/4 (8) where C is a circumference of the container, said circumference circumference of the container varying approximately as s: Cₙ=C₁[1+α(Tₛₙ−Tₛ₁)] (9) where α is a constant CTE of the container, in such a way that, by using (9) and (8), the volume at process time t is given by: V=h π{{{C[1+α(T_{c}−T_{c1})[}/π}²/4} (10);
iii) deriving a shrinkage sₙ of the sample as a percentage using: sₙ=100×[(V₁−Vₙ)/V₁] (11)
iv) determining a density of the sample, using: ρ_{ι}=m/Vᵢ (12), where the sample has a constant mass m;
v) computing a speed of sound in the sample using: vₛᵢ=(2hᵢ)/TOFₛᵢ (13) considering that a temperature of the sample is equal to a measured temperature of the test coupling medium at a process time ti, TOFₛ₁ being a time of flight between the first reflected signal from the interface between the test coupling medium and the sample; and
vi) deriving a modulus of the sample using: Mᵢ=ρ_{ι}(vₛᵢ)² (14) where the terms on the right hand side are results of equations (12) and (13).

The present invention still provides a method for: computing a thickness of the sample by measuring a time of flight TOF_{c} between the first and second echoes from the interface between the test coupling medium and the sample using the relation h=L−w where w is given by: w=v_{c}×TOF_{c}/2 (3) where v_{c} is a speed of sound in the test coupling medium at a temperature T_{c} of the test coupling medium; computing the volume V of the sample as a product of the thickness h by a cross sectional area Ai of the container, as follows: V=hπ[C/π]²/4 (8) where C is a circumference of the container, said circumference circumference of the container varying approximately as s: Cₙ=C₁[1+α(Tₛₙ−Tₛ₁)] (9) where α is a constant CTE of the container, in such a way that, by using (9) and (8), the volume at process time t is given by: V=hπ{{{C[1+α(T_{c}−T_{c1})]}/π}²/4} (10); deriving a shrinkage sₙ of the sample as a percentage using: sₙ=100×[(V₁−Vₙ)/V₁] (11); determining a density of the sample, using: ρ_{ι}=m/Vᵢ (12), where the sample has a constant mass m; computing a speed of sound in the sample using: vₛᵢ=(2hᵢ)/TOFₛᵢ (13) considering that a temperature of the sample is equal to a measured temperature of the test coupling medium at a process time ti, TOFₛ₁ being a time of flight between the first reflected signal from the interface between the test coupling medium and the sample;-and deriving a modulus of the sample using: Mᵢ=ρ_{ι}(vₛᵢ)² (14) where the terms on the right hand side are results of equations (12) and (13).

It is to be noted that the term shrinkage should not be understood in a restricted meaning as a reduction in volume due to thermal contraction, but so as to include an increase in volume due to thermal expansion, i.e. negative shrinkage.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a block diagram of a system according to an embodiment of a first aspect of the present invention; and

FIG. 2 is a is a simplified side view of a test unitcomprised in the system of FIG. 1;

FIG. 3 is a flow chart of a method according to an embodiment of a second aspect of the present invention;

FIG. 4 is a graph of amplitude versus time of a signal obtained in step 130 of the method of FIG. 3; and

FIG. 5 is a graph of amplitude versus time of a signal as obtained in step 170 of the method of FIG. 3; and

FIG. 6 is a graph of shrinkage and modulus of a sample versus time as obtained using the system of FIG. 1 and the method of FIG. 3.

### DESCRIPTION OF THE PREFERRED EMBODIMENT

Generally stated, the present invention provides a system and a method allowing to monitor physical properties such as shrinkage and stiffness of polymeric resins as they solidify.

More precisely, the present invention uses ultrasonic waves propagating through a sample of a polymeric resin under study.

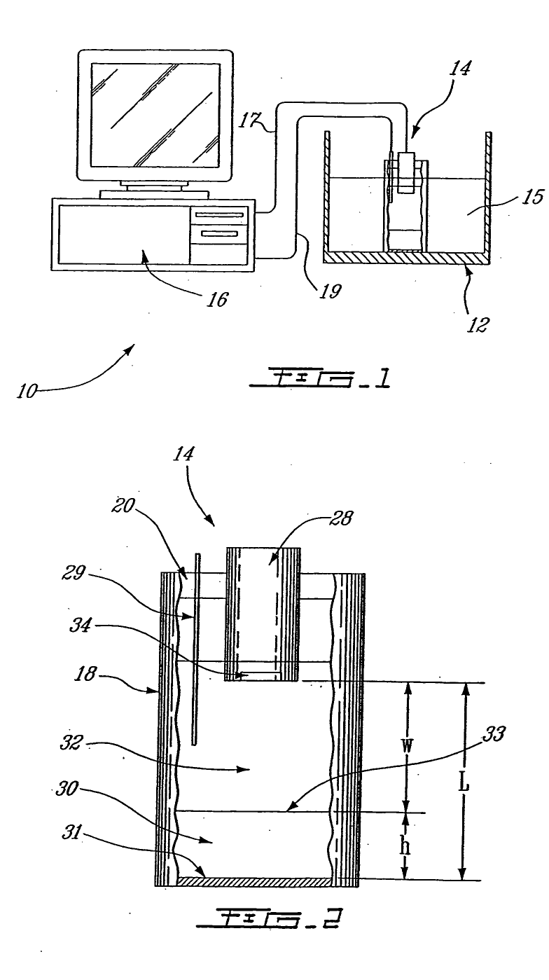

Turning first to FIG. 1 of the appended drawing, a system according to an embodiment of the first aspect of the present invention will now be described.

The system 10 generally comprises a temperature control unit 12; a test unit 14; and a processing unit 16.

The temperature control unit 12 may be a liquid bath 15 of a controlled temperature, in which the test unit 14 is placed.

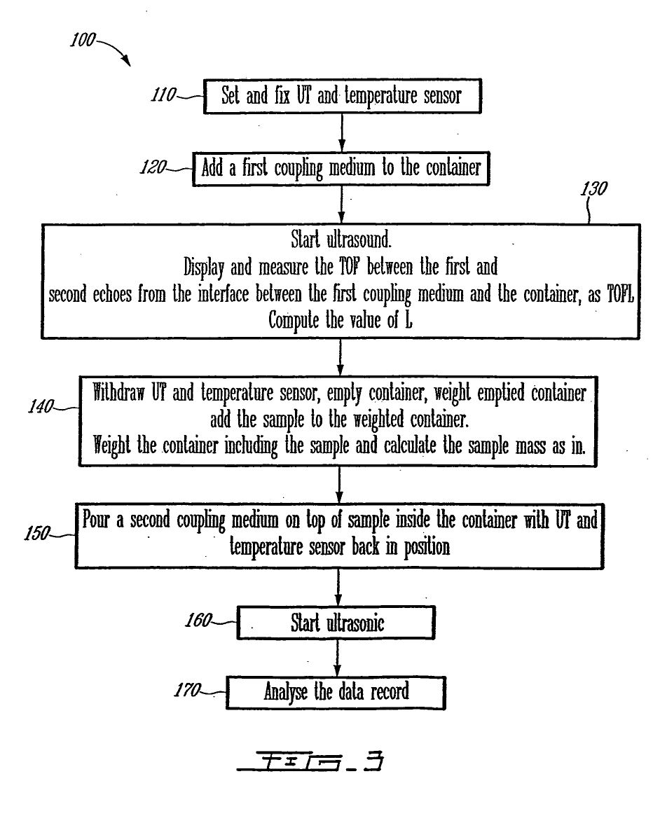

The test unit 14, as is best seen in FIG. 2, comprises a container 18, which may be provided with a cover 20 having passageways for holding a temperature sensor 29 and an ultrasonic transducer (UT) 28. The UT 28 is therefore fixed axially in a number of positions relative to an inside bottom surface 31 of the container 18. Although the present embodiment makes use of a cover arrangement of the container 18 to provide such fixed position of the UT 28, it is believed to be within the reach of people in the art to provide other arrangements that achieve the same without departing from the teachings of the present invention.

A sample 30 and a coupling medium (or couplant) 32 are placed in the container 18, the sample 30 being at the bottom thereof and the coupling medium 32 being on top of the sample 30, in such an amount to immerse a transducing element 34 of the UT 28 and the temperature sensor 29 to an appropriate depth. The coupling medium 32 allows the transmission of ultrasonic waves from the transducing element 34 of the UT 28 into the sample 30.

The UT 28 produces an ultrasonic signal characterized by a power and time envelope permitting at least two first reflections from the interface 33 between the coupling medium 32 and the sample 30 as well as the first reflection from the interface 31 between the sample 30 and the container 18, to be resolved in amplitude (above signal noise) and in time (between interface reflections). The repetition rate of the UT 28 is variable. It is to be noted that the UT 28 acts in a pulse/echo mode, i.e., it is both the transmitter of the ultrasound and the receiver of ultrasound that is reflected from material interfaces.

The processing unit 16 is used to produce and receive electrical signals, acquire and analyse received signals, and compute, display and store results of signal analysis. Typically, the processing unit 16 comprises a PC with hardware and software allowing sending electrical signals 17 to, and receiving electrical signals from, the UT 28, receiving electrical signals 19 from the temperature sensor 29 (see FIG. 1), processing the received signals for display in real time, and storage for post-processing.

In operation, the system 10 allows ultrasonic signals to be sent to the sample 30 by the transducing element 34 of the UT 28 through the coupling medium 32. Roughly stated, a first part of the ultrasonic signals is reflected twice at the interface 33 between the sample 30 and the coupling medium 32 back to the transducing element 34. A second part of the signals propagates through the thickness W of the sample 31 and then reflects at the interface 31.

The time of travel, referred to as the time of flight (TOF), of the first part of the signal between two successive echoes from the interface 33 yields the position of this interface 33 with respect to the transducing element 34, which is in a fixed position. This information is used to determine the shrinkage of the sample 30. The time of flight of the second part of the signal between a first reflected signal at the interface 33 between the coupling medium 32 and the sample 30, and a first reflected signal at the interface 31, is used to determine the stiffness of the sample. The time of flight is typically of the order of ten microseconds and the change in thickness of the sample 30 is typically of the order of a few hundred micrometers.

Then the processing unit 16 of the system 10 is used for signal acquisition, by using an AND converter with a sampling frequency at least ten times greater than a central frequency of the UT 28. The processing unit 16 permits the display and storage of signals. It also permits a variable number of signals to be averaged and displayed in real time, and the storage of the averaged signal for analysis. Moreover, post-processing of individual signals and on-screen reproduction of an entire sequence of signals from a user-specified set of recorded data files may be contemplated. An analysis of the signals involves determining various TOF to material interfaces as will be described further below. This data along with process times tᵢ and temperatures Tᵢ, are used to compute and display shrinkage and modulus as solidification progresses.

Turning now to the flow chart of FIG. 3, a method according to an embodiment of the second aspect of the present invention will be described with reference to the system 10 described hereinabove, for clarity purpose.

In a first step 110, the vertical positions of the UT 28 and of the temperature sensor 29 are set and fixed through passageways of the cover 20 for example.

In step 120, a first coupling medium, referred to hereinafter as the calibration coupling method 32, is selected. Any coupling medium in which the speed of sound at a current test temperature v(T) is well characterised may be used, since this step mainly aims at determining a distance L between the UT 28 and the inside bottom surface 31 of the container 18. Conveniently, distilled water may be used as the coupling medium for that stage. This coupling medium 32 is added to the container 18 in such a way as to partially immerse the UT 28 and the temperature sensor 29 when these are held in place by the cover 20 on top of the container 18.

The transmission of ultrasound signals into the contents of the container 18 is then started (step 130). The measure of the TOF between the first and second echoes from the interface 31 between the calibration coupling medium 32 and the container 18 is recorded as TOF_{L} (in absence of a sample 30). The value of the distance L between the UT 28 and the interface 31 is computed using the definition of speed (ratio of the distance over time), knowing the speed v(T) of sound in the calibration coupling medium 32 at a temperature T, according to the following equation:
L=v(T)×(TOF_{L}/2) (1)
TOF_{L} corresponds to twice the distance L.

Keeping the UT 28 and the temperature sensor 29 in their fixed position in the passageways of the cover 20, the cover 20 is removed from the top of the container 18 to allow removing the coupling medium 32 therefrom so as to weigh the emptied container 18 (step 140). Then, the sample 30 is carefully introduced into the weighed container 18 before the container 18 containing the sample 30 is weighed again so as to calculate the mass m of the sample 30 as the difference between the two measured masses.

A second coupling medium, referred to hereinafter as the test coupling 32′ is then selected. The test coupling medium 32′ has not only a well-characterised speed of sound versus temperature, but is also compatible with the sample 30 and the test conditions For example, the test coupling medium 32′ is inert with respect to the sample 30, is less dense than the sample 30 and does not mix with the sample 30. Moreover, the speed of sound in the test coupling medium 32′ is well characterised over the temperature range of the test. Therefore, the test coupling medium 32′ may or may not be the same as the calibration coupling medium 32. The test coupling medium 32′ is carefully added to the container 18 on top of the sample 30 so that the sample surface is not disturbed by the flow, and so as to partially immerse the UT 28 and the temperature sensor 29 (step 150).

In step 160, ultrasound transmission is activated into the content of the container 18, yielding signals comprising first and second echoes from the interface 33 between the test coupling medium 32′ and the sample 30, and the first echo from the interface 31 between the sample 30 and the container 18.

These signals are stored together with the corresponding process time t₁ and coupling medium temperature T_{c1} where the subscript “1” refers to the first data record. The first data record is then analysed as described further hereinbelow (step 170).

If the solidification process is not completed, the process is started over from step 160 and the data record number n is incremented by 1. Otherwise the test is terminated.

It is to be understood that in step 140, the test coupling medium 32′ may be different from the calibration coupling medium 32 used in step 120 in case this calibration coupling medium 32 is distilled water for example. However, it is possible to use similar coupling media 32, 32′ in both steps 120 and 140, provided they meets the requirements cited in relation to step 140.

During the analysis step 170, TOF (times) between reflections from the different interfaces are determined and converted into lengths using the speed of sound in the coupling media. The lengths in turn permits to compute a number of material parameters, including the sample thickness h(t), the sample volume V(t) and the sample density p(t), from which the sample shrinkage and the sample modulus M(t) may be derived. As the sample solidifies, measurements of TOFᵢ and temperature Tᵢ are made at process times tᵢ, allowing computing the values of the parameters as functions of the process time tᵢ. It is to be noted that the temperature Tᵢ is also a function of the process time tᵢ.

In the case of the first data record (denoted by the subscript n=1), the analysis first comprises computing the thickness h₁ (t) of the sample 30 by measuring TOF_{c1} between the first and second echoes from the interface 33 between the coupling medium 32 and the sample 30, using the following relation:
h₁=L−w₁ (2)
where L is the fixed distance between the UT 28 and the inside bottom surface 31 of the container 18 as computed hereinabove through equation (1), and w₁ is given by the following relation:
w₁=v_{c1}×TOF_{c1}/2 (3)
where v_{c1} is the speed of sound in the test coupling medium at temperature T_{c1} of the test coupling medium. Then the value h₁ is computed by substituting L from (1) and w₁ from (3) in (2).

Secondly, the analysis involves computing the volume V₁ of the sample 30, considering that the volume V₁ is the product of thickness h₁ by a cross sectional area A₁ of the container 18, as follows:
V₁=h₁×A₁ (4)
where the cross sectional area A₁ of the container 18 is given by:
A₁=πD₁²/4 (5)
and D₁=C₁/π (6), D and C are the diameter and circumference respectively, of the container 18. Therefore,
A₁=π[C₁/π]²/4 (7)
And, substituting (7) into (4), the following equation is obtained:
V₁=h₁π[C₁/π]²/4 (8)

Typically, since the cross sectional area of the container 18 is liable to change due to a coefficient of thermal expansion (CTE) of the material forming the container 18, the circumference of the container varies approximately as follows:
Cₙ=C₁[1+α(Tₛₙ−Tₛ₁)] (9)
where α is the CTE, considered a constant, of the container 18 (it may be known from published data or from measurements on the container), and the subscript n indicates a number of a data record. Using (9) and (8), the result for a data record n reads as follows:
Vₙ=hₙπ{{{C₁[1+α(T_{cn}−T_{c1})]}π/}²/4} (10)
Obviously, for the first data record, i. e when n=1, equation (8) holds since α(T_{cn}−T_{c1})=0.

A third computation performed during the analysis relates to the shrinkage of the sample 30, generally defined as a percentage using the following equation:
sₙ=100×[(V₁−Vₙ)/V₁] (11)
For the first data record n=1 and s₁=0%. Obviously, an expansion may be also measured, and is recorded as a negative shrinkage.

A further parameter determined during the analysis step is the density of the sample, defined by: ρ₁=m/V₁ (12), wherein the mass m of the sample is taken as a constant throughout the test.

Additionally, the analysis comprises the computation of the speed of sound in the sample 30, which is given by:
vₛ₁=(2h₁)/TOFₛ₁ (13)
considering that the temperature of the sample 30 is equal to the measured temperature of the test coupling medium. TOFₛ₁ is the time of flight between the first echo from the interface 33 between the test coupling medium and the sample 30, and the first echo from the interface 31, and corresponds to twice the distance travelled by a sound wave in the sample 30.

Finally, the analysis permits the determination of a modulus of the sample 30 by the following equation:
M₁=ρ₁(vₛ₁)² (14)
where the terms on the right hand side are results of equations (12) and (13).

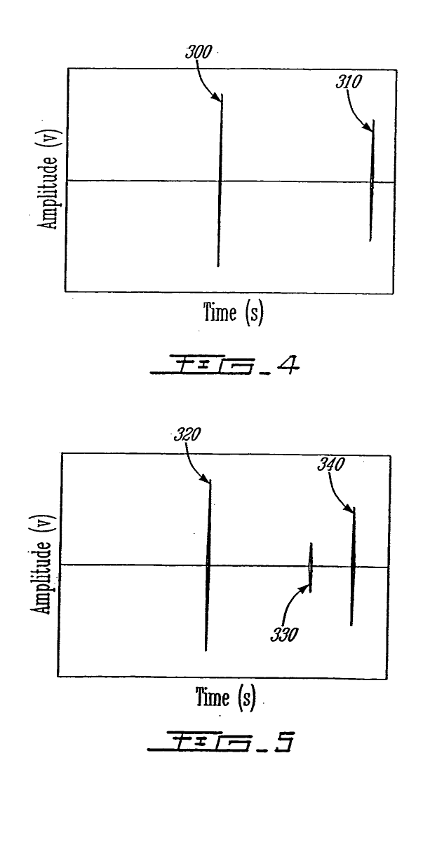

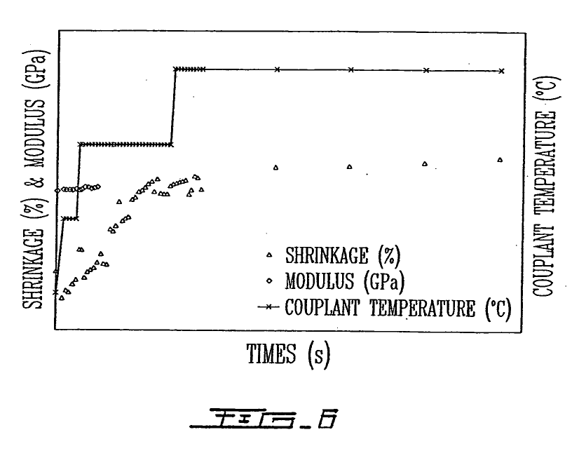

An example of the above-described method will now be described in relation to FIGS. 4 and 5.

After the UT and the temperature sensor are set in position (step 110), distilled water may be chosen as the calibration coupling medium (step 120) and the UT 28 is activated (step 130).

FIG. 4 shows a first and a second echo (300 and 310 respectively) from the interface 31 between the calibration coupling medium 32 and the container 18 in absence of a sample 30. The TOF_{L}, as measured from the time difference between the two echoes, is 42.29 microseconds. The speed of sound in distilled water at T=22.0° C. is assessed by means of a relation known in the art (Landolt-Börnstein, Numerical Data and Functional Relationships in Science and Technology, New Series, Group II: Atomic and Molecular Physics, Vol. 5—Molecular Acoustics, Hellwege, K.-H. and Hellwege, A. M., eds., Springer-Verlag, Berlin, 1967, p.69), which gives v=1488.63 m/s. The distance between the UT 28 and the interface 31 between the coupling medium (here distilled water) and the container 18 is given by means of equation (1). It is found, in the present example, to have a value of L=0.031477 m.

The container 18 is then emptied of the calibration coupling medium 32, while taking care of maintaining the UT 28 and the temperature sensor 29 in their fixed position in the cover 20. The empty container 18 is then weighed, before the sample 30 is added thereinside, care being taken so that none of the sample 30 sticks to inside walls of the container 18, and the container 18, with the sample 30 inside, is weighed again, so as to yield the sample mass by difference (here, m=0.01700 kg) (step 140).

A low-density oil having a known speed of sound as a function of temperature may be selected as the test coupling medium 32′ (step 150). In the present example, the relation is: v_{c}(T)=1329.0−(3.7 T) m/s. This test coupling medium 32′ is added on top of the sample 30 in sufficient quantity to partially immerse the UT 28 and the temperature sensor 29 when the cover 20 supporting them is placed back on top of the container 18.

Then, ultrasound transmission is started again (step 160), and the first data record is acquired and analyzed (step 170). FIG. 5 shows a signal having a peak 320 corresponding to a first echo from the interface 33 between the coupling medium 32′ and the sample 30; a second peak 330 corresponding to the first echo from the interface 31 between the sample 30 and the container 18; and a third peak 340 related to the second echo from the interface 33 between the sample 30 and the coupling medium 32′.

The TOF_{c1} from the stored signal may then be measured. It is, in the present example, TOF_{c1}=41.720 microseconds. Using equation (3), at a temperature T_{c1}=22.0° C. giving v_{c1}=1247.6 m/s, w₁=(1247.6×41.720×10⁻⁶)/2=0.026025 m is found. Using equation (2), the sample thickness is computed, yielding h₁=0.031477−0.026025=0.005452 m. The volume of the sample is computed by means of equation (8), knowing the properties of the material of the container 18 (constant α=15.0×10⁻⁶ per degree Celsius, C₁=0.142958 m, and T_{c1}=22.0° C.). The volume of the sample in the present example is thus found to be V₁=8.867×10⁻⁶ m³.

The shrinkage is then computed using (11) and is 0% for the first record.

The sample density ρ₁ amounts to 1917.2 kg/m³ and the speed of sound in the sample is calculated as vₛ₁=2×h₁/TOFₛ₁=525.24 mls where TOFₛ₁ is the time of flight between the first echo (320) from the interface 33 and the first echo (330) from the interface 31, and corresponds to twice the distance travelled in the sample (TOFₛ₁=20.760 microseconds). Finally, a sample modulus M₁ of 0.529 GPa is calculated using equation (14).

In the case of the first data record (n=1), the solidification process is not completed, and the above steps are repeated from step 160 by incrementing the data record number by 1, and another signal is recorded. Taking for example, the data record n=10, the TOF are measured and are found to be TOF_{c10}=44.380 microseconds and TOFₛ₁₀=19.590 microseconds. The temperature is measured to be T_{c10}=40.5° C. Other parameters are determined as described hereinabove: v_{c10}=1179.15 m/s; w₁₀=26.165 mm; h₁₀=5.32 mm; C₁₀=0.142958 m; V₁₀=8.643.10⁻⁶ m³; s₁₀=2.52%; ρ₁=1966.84 kg/m³, vₛ₁₀=542.28 m/s; M₁₀=0.578 GPA.

When the solidification process is completed, the test is over. The evolution of shrinkage and modulus may be displayed in real time to a user during the test, while they are being collected and analysed, in plots such as the one presented in FIG. 6.

FIG. 6 shows results obtained from a Dow Derakane resin sample placed in a bath maintained at 30° C.

A first curve shows the variation of the temperature of the coupling medium (cross symbols). The temperature of the coupling medium varies from 27° C. to 28° C. after a delay of 5 minutes, increases to 29° C. after 20 minutes, and reaches the bath temperature of 30° C.

A second curve relates to the change in modulus (dot symbols). It is observed that the modulus remained constant for about 1.5 hours since the beginning of the test, at a value corresponding to the liquid phase of the sample. The modulus signal was lost at that point and picked up again after about 8 hours of testing, after which time it remained slightly constant at a value corresponding to the solid phase of the sample.

A third curve relates to the shrinkage of the sample during the test (triangle symbols). At the onset of the test, a negative shrinkage, corresponding to expansion, is observed. Then, shrinkage is positive and increases to reach a plateau after about 8 hours of testing, which corresponds to the end of the solidification process of the sample. Apart from absolute value of shrinkage or expansion, such a curve also indicates the rate of shrinkage and the time of reversal from expansion to contraction.

From FIG. 6, it is therefore apparent that the system and method of the present invention allows for the monitoring of the expansion characteristics of the resin, the time at which the reversal from expansion to contraction takes place, the rate of shrinkage of the resin, the actual shrinkage of the resin, the modulus of the resin in the liquid state, and the modulus of the resin after the gelling has taken place.

As will be apparent to people in the art, the system and the method of the present invention enable the measurement of the history of (contraction/expansion) and stiffness of a sample during the solidification, which may be of great value to control dimensions and stiffness of final product in the field of high tech applications such as aircraft, space components, dental applications, automobiles etc., or in applications of new polymeric resins, in which developers need to learn how these new resins perform in terms of shrinkage and stiffness.

Furthermore, it is to be noted that the system and method of the present invention use environment-friendly materials and does not require high pressure, thereby avoiding environmental hazards and allowing to reduce set-up and operation times. Obviously, the system and method may be adapted to automatically record, treat and display results in real time at specified intervals, in such a way that no further user intervention is required once the set-up is performed.

1. A system for measuring a shrinkage behavior and modulus change during solidification of a polymeric resin making use of ultrasound signals, comprising:
an ultrasonic transducer; and
a container containing a sample of the polymeric resin and a coupling medium, said coupling medium being on top of the sample and in such an amount as to partially immerse the ultrasonic transducer held in a fixed vertical position relative an inside bottom surface of the container;
wherein the coupling medium transmit an ultrasonic signal from the ultrasonic transducer to the sample, said ultrasonic transducer producing the ultrasonic signal characterized by a power and time envelope allowing at least two first reflections from an interface between the coupling medium and the sample and a first reflection from an interface between the sample and the inside bottom surface of the container.

2. The system according to claim 1, wherein a first part of the ultrasonic signal is reflected twice at the interface between the sample and the coupling medium back to the ultrasonic transducer, and a second part the ultrasonic signal propagates through a thickness W of the sample and reflects on the inside bottom surface of the container; a time of travel of said first part of the signal is used to determine the shrinkage of the sample and a time of travel of said second part is used to determine a stiffness of the sample.

3. The system according to claim 2, wherein the times of travel are of the order of ten microseconds.

4. The system according to claim 1, further comprising a temperature control unit and a temperature sensor.

5. The system according to 4, wherein said temperature control unit is a liquid bath of a controlled temperature in which the container is placed and said temperature sensor monitors a temperature of the coupling medium.

6. The system according to claim 3, further comprising a processing unit allowing sending electrical signals to the ultrasonic transducer, receiving electrical signals from the ultrasonic transducer, and processing the received signals for display in real time, and storage for post-processing.

7. The system according to claim 4, further comprising a processing unit allowing sending electrical signals to the ultrasonic transducer, receiving electrical signals from the ultrasonic transducer, receiving electrical signals from the temperature sensor, and processing the received signals for display in real time, and storage for post-processing.

8. The system according to claim 6, wherein said processing unit comprises an A/D converter with a sampling frequency at least ten times greater than a central frequency of the ultrasonic transducer.

9. The system according to claim 1, wherein said container comprises a cover provided with passageways for insertion of the ultrasonic transducer.

10. The according to claim 4, wherein said container comprises a cover provided with passageways for insertion of the ultrasonic transducer and of the temperature sensor.

11. The system according to claim 1, wherein said coupling medium has a well-characterised speed of sound versus temperature, is compatible with said polymeric resin sample and with test conditions.

12. The system according to claim 11, wherein said coupling medium is inert with respect to the polymeric resin, is less dense than the polymeric resin, does not mix with the polymeric resin and such that a speed of sound in said coupling medium is well characterized over a temperature range.

13. The system according to claim 1, wherein said coupling medium is a low-density oil.

14. A method for measuring a variation of material parameters of a polymeric resin upon solidification thereof, comprising the steps of:
a) providing a sample of the polymeric resin in a container;
b) providing a test coupling medium on top of the sample of the polymeric resin in the container;
c) providing an ultrasonic transducer in a fixed position relative an inside bottom surface of the container and partially immersed in the test coupling medium;
d) allowing the ultrasonic transducer to send a signal to the sample through the test coupling medium;
e) collecting a first reflected signal and a second reflected signal from an interface between the test coupling medium and the sample, and a first reflected signal from the interface between the sample and the inside bottom surface of the container;
f) storing the reflected signals with a corresponding process time t and test coupling medium temperature T_{c} at the time;
g) repeating steps d) to f) until solidification of the sample is complete; and
h) processing the reflected signals.

15. The method according to claim 14, further comprising before step a) a step of determining a distance L between the ultrasonic transducer and the inside bottom surface of the container, said step comprising:
providing a calibration coupling medium having a know speed of sound versus temperature v(T) in the container in absence of the sample;
starting transmission of ultrasonic signals;
measuring a time of flight TOF_{L} between a first and a second echoes from an interface between the calibration coupling medium and the inside bottom surface of the container;
computing a distance L between the ultrasonic transducer and the interface between the calibration coupling medium and the inside bottom surface of the container as L=v(T)×(TOF_{L}/2); and
emptying the calibration coupling medium from the container.

16. The method according to claim 15, wherein said step of providing a calibration coupling medium comprises selecting a coupling medium compatible with the sample and solidification conditions.

17. The method according to claim 15, wherein said step of providing a calibration coupling medium comprises selecting a coupling medium inert with respect to the sample, less dense than the sample, not mixing with the sample and such that the speed of sound v(T) therein is well characterized over a temperature range of the solidification of the sample.

18. The method according to claim 15, wherein said step of providing a calibration coupling medium comprises selecting a coupling medium similar to the test coupling medium.

19. The method according to claim 15, further comprising before step a) a step of determining a mass of the sample, and step comprising:
weighing the container when empty;
introducing the sample inside the weighed container;
weighing the container with the sample inside; and
calculating the mass of the sample by a difference between the two measured masses.

20. The method according to claim 11, wherein said step of processing the reflected signals and comprises:
determining times of flight between reflections and temperature as the sample solidifies as functions of a process time t,
converting the times of flight into lengths using a known speed of sound in the test coupling medium;
using the calculated lengths to compute a number of test parameters as a function of the process time t, including the sample thickness, the sample volume and the sample density, and
deriving from the computed parameters the sample shrinkage and modulus as a function of the process time t; and
terminating when solidification of the sample is complete.

21. The method according to claim 15, wherein said step of processing the reflected signals comprises:
vii) computing a thickness of the sample by measuring a time of flight TOF_{c} between the first and second echoes from the interface between the test coupling medium and the sample using the relation h=L−w where w is given by: w=v_{c}×TOF_{c}/2 (3) where v_{c} is a speed of sound in the test coupling medium at a temperature T_{c} of the test coupling medium;
viii) computing the volume V of the sample as a product of the thickness h by a cross sectional area Ai of the container, as follows: V=hπC/π]²/4 (8) where C is a circumference of the container, said circumference of the container varying approximately as s: Cn−C₁[1+α(Tₛₙ−Tₛᵢ)] (9) where α is a constant CTE of the continer, in such a way that, by using (9) and (8), the volume at process time t is given by: V=hπ{{{C[1+α(T_{c}−T_{c1})]}/π}²/4} (10);
ix) deriving a shrinkage sₙ of the sample as a percentage using: sₙ=100×[(V₁−Vₙ)/V₁] (11);
x) determining a density of the sample, using: ρ₁=m/Vᵢ (12), where the sample has a constant mass m;
xi) computing a speed of sound in the sample using: vₛᵢ=(2hᵢ)/TOFₛᵢ (13) considering that a temperature of the sample is equal to a measured temperature of the test coupling medium at a process time ti, TOFₛ₁ being a time of flight between the first reflected signal from the interface between the test coupling medium and the sample; and
xii) deriving a modulus of the sample using: Mᵢ=ρ₁(vₛᵢ)² (14) where the terms on the right hand side are results of equations (12) and (13).
